(19) United States
(12) Patent Application Publication
(10) Pub. No.: US 2006/0238766 A1
(43) Pub. Date: Oct. 26, 2006

(54) Surface plasmon resonance sensor

(75) Inventor: Neil Polwart, Polmont (GB)

Correspondence Address: FLESHNER & KIM, LLP, P.O. BOX 221200, CHANTILLY, VA, 20153, US

(73) Assignee: PACIFIC SHELF 1258 LIMITED, Linlithgow (GB)

(21) Appl. No.: 10/540,945

(22) PCT Filed: Dec. 31, 2003
(86) PCT No.: PCT/GB03/05716

§ 371 Date: Jan. 4, 2006

(30) Foreign Application Priority Data
Jan. 2, 2003 (GB) 0300001.5

(51) Int. Cl. G01N 21/55

(52) U.S. Cl. 356/445

(57) ABSTRACT

An improved Surface Plasmon Resonance Sensor (8) is described that is compact, simple to align and cost effective to produce, thus making the device highly mobile and so idea for field applications. These characteristics are achieved through the employment of a pre-formed cartridge (10) that provides for the required manipulation of a beam of light (2) used within the surface plasmon resonance process. The cartridge (10) is easily interchangeable and so provides a high degree of flexibility to the sensor (8). The device therefore provides a fast and simple means for the on site testing of fluids for the presence of harmful fluid borne bacterium. Particular application of the device is the testing of water samples obtained from industrial or recreational sources for the presence of the Legionella bacteria.

This invention relates to a Surface Plasmon Resonance Sensor. In particular it relates to an improved design of Surface Plasmon Resonance Sensor that is compact, simple to align and cost effective to produce, thus making it ideal for field applications.

The phenomenon of Surface Plasmon Resonance (SPR) is well known to those skilled in the art having being first demonstrated over twenty five years ago. Surface Plasmon Resonance is a charge-density oscillation that may exist at the interface of two media that exhibit dielectric constants of opposite signs, for example a metal and a dielectric.

Surface Plasmon Resonance sensors described in the Prior art generally comprise an optical system, a transducing medium that generally combines the optical system and the relevant chemical or biochemical domains, and an electronic system that supports the optoelectronic components of the sensor, and allows for the required data processing. The devices come in three main configurations namely:
(1) Prism coupler based systems;
(2) Grating coupler based systems; or
(3) Optical waveguide based systems.

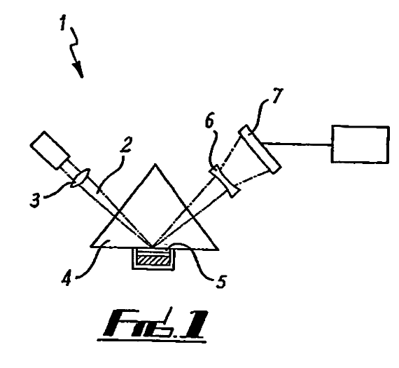

A typical prism coupler based system 1 is presented schematically in FIG. 1. This system is generally accepted as being the best suited for sensing and therefore has become the most widely employed system in the art. In this configuration a light wave 2 passes through a first element of an optical system 3 before passing into a prism 4. Thereafter, the light wave 2 experiences total internal reflection at the interface between the prism 4 and a thin metal layer 5 (typically of a thickness of around 50 nm). The light wave 2 then passes through a second element of the optical system 6 that acts to manipulate the light wave 2 such that it becomes incident on a detector 7.

The Surface Plasmon Resonance sensor 1 is an ideal medium for analysing samples that become attached to the metal layer 5. SPR is a phenomenon that occurs when light incident upon the metallic layer 5 provides an absorption energy capable of vibrationally exciting the packets of electrons (or plasmons) located on the surface of the metal layer 5. As such the energy required to achieve SPR is highly dependent upon the dielectric constant of the species at the surface of the metal, the wavelength of the light wave 2 and the angle of incidence of the light wave 2.

As is known in the art the use of a particular monochromatic light source of a known wavelength incident at variable angles, or across a range of known angles, allows a reference Reflectance Angle versus Intensity data to be recorded. The presence of any foreign bodies that become attached to the surface of the metal layer 5 then act to change the value of the dielectric constant experienced by the light wave 2 at the surface of the metal layer 5. As such the presence of these foreign bodies can be easily detected and thereafter quantified by monitoring the profile of the Reflectance Angle versus Intensity curves.

The systems described in the Prior Art are difficult to optically align and so require a skilled operator. Furthermore the systems are not easily miniaturised and as such are not easily adapted to be used as field based instruments. Generally, a user is required to take a sample that then needs to be taken to the laboratory for testing by the operator. This process can lead to significant delays in obtaining results. Such delays can be fatal when the instrument is employed as a biosensor to detect particular pathogens.

It is an object of an aspect of the present invention to provide a Surface Plasmon Resonance Sensor that overcomes one or more of the limiting features associated with the apparatus and methods described in the prior art.

According to a first aspect of the present invention there is provided a cartridge for use in a Surface Plasmon Resonance sensor, the cartridge comprising an optical element having a first surface and a mounting member for supporting a sensing agent located on a second surface of the optical element wherein the first surface comprises a first means for directing a beam of light incident on the optical element towards the second surface at an angle of incidence to the second surface that results in substantially total internal reflection of the beam of light at an interface of the mounting member and the second surface.

Most preferably the optical element further comprises a third surface for the exit of the beam of light from the optical element wherein the third surface includes a second means for directing the beam of light.

Preferably the optical element comprises a material having a first dielectric constant while the mounting member comprises a material having a second dielectric constant wherein the second dielectric constant is of an opposite sign to that of the first dielectric constant.

Most preferably the first means for directing the light beam comprises a focusing element for focusing the beam of light to a line at the interface of the mounting member and the second surface.

Preferably the second means for directing the light beam comprises a defocusing element.

Preferably the mounting member comprises a metal.

Preferably the optical element comprises an injection moulded plastic material.

Most preferably the sensing element comprises one or more antibodies each antibody being suitable for binding a pathogen.

Preferably the bound pathogen is selected from the group comprising Legionella, Escherichia coli, Salmonella, Bacillus Anthracis, Yersinia Pestis, Lysteria, Cryptosporidium, Variola virus, Picomaviridae Apthovirus, Filoviruses, any plasticiser, steroid, medicinal drug or illicit substance or any other known fluid borne bacterium.

Preferably a protein substrate and a ligand is employed to bind a biotinylated antibody to the metal.

Preferably the protein substrate comprises biotin.

Preferably the ligand comprises a protein selected from the group comprising avidin, strepavidin and neutravidin.

According to a second aspect of the present invention there is provided a Surface Plasmon Resonance sensor comprising a light source for generating a beam of light, a cartridge according to the first aspect of the present invention, a channel suitable for containing a fluid sample to be tested and a light beam detection means wherein the employment of the cartridge allows for the miniaturisation of the sensor.

Most preferably the light source comprises a diode laser.

Preferably the channel locates on the second surface of the cartridge such that the fluid sample contained within the cartridge makes physical contact with the mounting member.

Preferably the light beam detection means comprises a detector and a data processing means.

According to a third aspect of the present invention there is provided a method of field detection of one or more pathogens comprising the steps of:
1) Selecting an appropriate cartridge for the detection of one or more pathogens for use in a Surface Plasmon Resonance sensor;
2) Calibrating the Surface Plasmon Resonance sensor; and
3) Testing a fluid sample for the presence of one or more of the pathogens;

Preferably the selection of the appropriate cartridge comprises locating the cartridge with one or more appropriate antibodies for binding with the one or more pathogens.

Preferably calibrating the Surface Plasmon Resonance sensor comprises:
1) Irradiating the mounting member with the beam of light in the absence of the fluid sample; and
2) Detecting a component of the beam of light reflected from the mounting member and storing the data as a reference signal;

Preferably testing of a fluid sample for the presence of one or more pathogens comprises:
1) Locating the fluid sample with respect to a channel;
2) Connecting the channel to the cartridge;
3) Irradiating the fluid sample with the beam of light;
4) Detecting the beam of light reflected from the mounting member and storing the data as a sample signal; and
5) Comparing the sample signal with the reference signal.

Embodiments of the invention will now be described, by way of example only, with reference to the accompanying drawings, in which:

FIG. 1 present a prism coupler based Surface Plasmon Resonance sensor as described in the Prior Art;

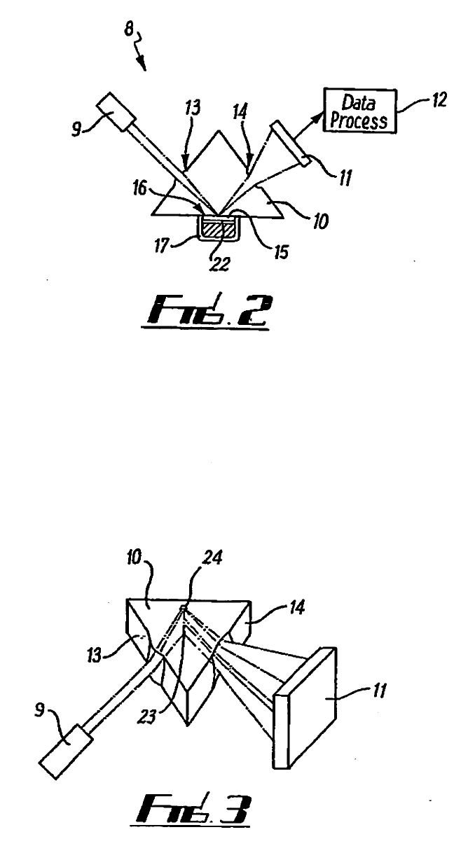

FIG. 2 present a disposable cartridge based Surface Plasmon Resonance sensor in accordance with an aspect of the present invention;

FIG. 3 present a schematic representation of the Surface Plasmon Resonance sensor of FIG. 2; and

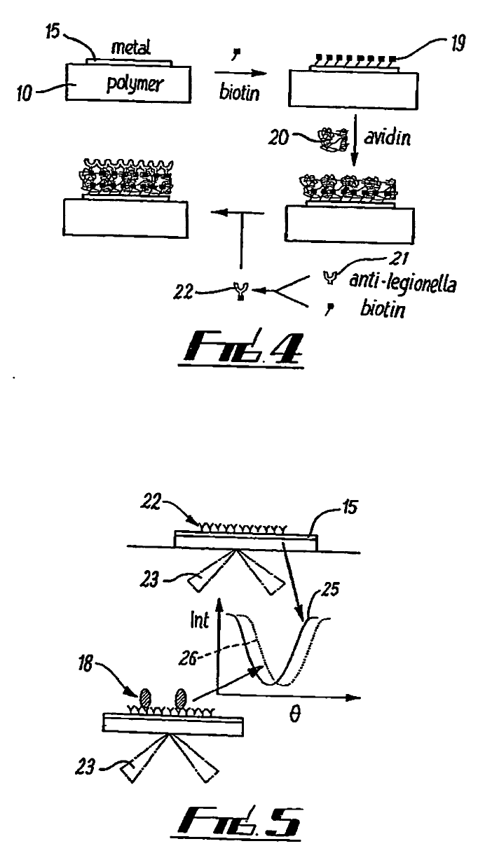

FIG. 4 present a schematic representation of a binding method employed by the Surface Plasmon Resonance sensor of FIG. 2; and

FIG. 5 presents typical Angle versus Intensity curves as may be obtained by the Surface Plasmon Resonance sensor.

FIGS. 2 and 3 present a disposable cartridge based Surface Plasmon Resonance sensor 8 in accordance with an aspect of the present invention. The sensor can be seen to comprise a diode laser 9, a disposable cartridge 10 and a charge coupled device (CCD) detector 11 that is connected to a data processing unit 12.

The disposable cartridge 10 comprises a shaped entrance surface 13, a shaped exit surface 14 and a gold strip 15 that is attached to a third side of the disposable cartridge 16. A channel 17 is employed to enclose the 2 gold strip so providing a means for containing and introducing a fluid sample to the surface of the gold strip 15. The disposable cartridge 10 can be detached from the channel 17 so as to enable the cartridge 10 to be disposed of and replaced, as required.

In order that the cartridge 10 be correctly aligned to the diode laser 9, the CCD detector 11 and located correctly with the channel 17, the channel 17 may further comprise either male of female members (not shown) that interact with female or male members, respectively, located on the surface of the cartridge 10.

For the Surface Plasmon Resonance sensor 8 to operate correctly there must be a means whereby the relevant pathogen 18 to be detected can attach to surface of the gold strip 15. There are several techniques known to those skilled in the art for binding pathogens 18 to a metal strip.

FIG. 4 presents a schematic representation of a binding method suitable for use with the Surface Plasmon Resonance sensor 8. The first stage involves binding a suitable protein substrate 19, for example biotin, to the surface of the gold strip 15. Stage two involves attaching a ligand 20 to the protein substrate 19. A suitable ligand 20 for conjugating with biotin is avidin although steptavidin or neutravidin may also be employed. The third stage then involves the attachment of an antibody 21, appropriate for the relevant pathogen 18 to be tested for, to the ligand 20. This attachment is achieved by employing antibodies 21 that have been biotinylated 22.

When the gold strip 15 has been treated as described above the Surface Plasmon Resonance sensor 8 is ready for use. The diode laser 9 provides the required light beam 23. The light beam 23 is focused to a line 24 on the gold strip 15 on passing through the shaped entrance surface 13. This provides a large area of interaction between the light beam 23 and the gold strip 15. Such an area of interaction allows a range of spatially resolved biotinylated antibodies 22 to be deposited on a single cartridge 10. The light beam 23 is then totally internally reflected so as to traverse through the shaped exit surface 14. This results in the light beam 23 being defocused such that the incident signal from each of the biotinylated antibodies 22 is spatially resolved across the whole area of the CCD detector 11. Data processing is then carried out on the detected signal, as appropriate.

FIG. 5 presents a schematic Reflectance Angle verses Intensity curves typically obtained by the Surface Plasmon Resonance sensor 8. The solid curve 25 corresponds to the case where no pathogen 18 is present in the fluid sample as indicated in FIG. 5(a). However, FIG. 5(b) shows the case when a pathogen 18 is present in the fluid sample, as represented by the broken curve 26. The pathogen 18 on becoming attached to the surface of the gold strip 15 alters the value of the dielectric constant experienced by the light beam 23 at the surface of the gold strip 15. As such the presence of the pathogen 18 alters the profile of the Angle versus Intensity curve, so permitting quick and easy detection of the presence of the pathogen 18.

The employment of the disposable cartridge 10 and a diode laser 9 light source provides the Surface Plasmon Resonance sensor 8 with significant inherent advantages over those taught in the Prior Art. In the first instance these elements significantly simplify the optical alignment requirements of the device as well as allowing for the significant miniaturisation of the device. As such, the Surface Plasmon Resonance sensor 8 provides a compact, simple to align and cost effective device for the field testing of the presence of a pathogen 18. The miniaturisation of the device has the added advantage that it increases the sensitivity of the sensor since all of the functionalised area of the gold strip 15 can be contained within the focused line 24 area of the incident light beam 23.

In particular, the fact that the focusing and defocusing elements are incorporated directly within the disposable cartridge 10 simplifies the time consuming alignment requirements associated with the optical systems 3 and 6 of the Prior Art sensors. In addition, the employment of an injection moulding technique allows for the low cost fabrication of the disposable cartridge 10. Such a technique therefore makes it cost effective to remove and dispose of the cartridge 10 after use and simply replace it with a new cartridge 10, as required. The use of these disposable cartridges 10 significantly reduces the time consuming cleaning requirements associated with the sensors described in the Prior Art.

An alternative embodiment of the Surface Plasmon Resonance sensor (not shown) the fluid sample to be tested is continuously passed through the channel 17 and across the surface of the gold strip 15. This allows for the Surface Plasmon Resonance sensor to continuously monitor a fluid source for the presence of a pathogen 18 rather than testing a single sample taken from the fluid source as discussed in relation to the above preferred embodiment.

The Surface Plasmon Resonance sensor 8 described herein is particularly suitable for the detection of the bacteria Legionella in water samples obtained from industrial or recreational sources. This is of particular importance in evaluating and controlling the risk to public health presented by the often-fatal condition Legionnaires disease and the less serious but far more common condition of Pontiac Fever. Existing techniques are either very slow or too labour intensive to meet market demands, since they generally require qualified microbiologists to perform testing at specialist laboratories.

The availability of the focused line 24 interaction area on the gold strip 15 allows for the functionalisation of the interaction area for different antibodies that are sensitive to different forms of the Legionella bacteria. Thus, the above apparatus provides a sensor that is capable of simultaneously detecting and discriminating between Legionella pnuemophilla serogroup 1 and Legionella serogroups 2-15.

Although ideal for the detection of the bacteria Legionella, it will be obvious to one skilled in the art that the surface Plasmon Resonance sensor may be easily adapted for use in the detection of alternative species e.g. Escherichia Coli, Salmonella, Bacillus Anthracis, Yersinia Pestis, Lysteria, Cryptosporidium, Variola virus, Picomaviridae Apthovirus, Filoviruses, any plasticiser, steroid, medicinal drug or illicit substance or any other known fluid borne pathogen.

In addition to the use for water quality monitoring as described above it would be obvious to one skilled in the art that the Surface Plasmon Resonance sensor 8 is also ideal for use in healthcare, especially for use as a point of care diagnostic.

Aspects of the present invention described above offer significant advantages over the Prior Art. In the first instance the Surface Plasmon Resonance sensor provides a compact, simple to align and cost effective device for the field testing of the presence of a pathogen. The device is ideal for the expeditious detection and identification of a range of pathogens. Further, the incorporation of the focused line area provides a means for carrying out such a detection and identification process simultaneously for a number of different pathogens.

The foregoing description of the invention has been presented for purposes of illustration and description and is not intended to be exhaustive or to limit the invention to the precise form disclosed. The described embodiments were chosen and described in order to best explain the principles of the invention and its practical application to thereby enable others skilled in the art to best utilise the invention in various embodiments and with various modifications as are suited to the particular use contemplated. Therefore, further modifications or improvements may be incorporated without departing from the scope of the invention herein intended.

1. A cartridge for use in a Surface Plasmon Resonance sensor, the cartridge comprising an optical element having a first surface and a mounting member for supporting a sensing agent located on a second surface of the optical element, the first surface comprising a first means for directing a beam of light incident on the optical element towards the second surface at an angle of incidence to the second surface that results in substantially total internal reflection of the beam of light at an interface of the mounting member and the second surface wherein the cartridge further comprises a detachable channel suitable for containing a fluid sample to be tested.

2. A cartridge as claimed in claim 1 wherein the channel locates on the second surface of the cartridge such that the fluid sample contained within the channel makes physical contact with the sensing agent.

3. A cartridge as claimed in claim 1 wherein the optical element further comprises a third surface for the exit of beam of light from the optical element wherein the third surface includes a second means for directing the beam of light.

4. A cartridge as claimed in claim 1 wherein the optical element comprises a material having a first dielectric constant while the mounting member comprises a material having a second dielectric constant wherein the second dielectric constant is of an opposite sign to that of the first dielectric constant.

5. A cartridge as claimed in claim 1 wherein the first means for directing the light beam comprises a focusing element for focusing the beam of light to a line at the interface of the mounting member and the second surface.

6. A cartridge as claimed in claim 3 wherein the second means for directing the light beam comprises a defocusing element.

7. A cartridge as claimed in claim 1 wherein the mounting member comprises a metal.

8. A cartridge as claimed in claim 1 wherein the optical element comprises an injection moulded plastic material.

9. A cartridge as claimed in claim 1 wherein the sensing agent comprises one or more antibodies each antibody being suitable for binding a pathogen.

10. A cartridge as claimed in claim 9 wherein the bound pathogen is selected from the group comprising Legionella, Escherichia coli, Salmonella, Bacillus Anthracis, Yersinia Pestis, Lysteria, Cryptosporidium, Variola virus, Picomaviridae Apthovirus, Filoviruses, any plasticiser, steroid, medicinal drug or illicit substance or any other known fluid borne bacterium.

11. A cartridge as claimed in claim 9 wherein a protein substrate and a ligand is employed to bind a biotinylated antibody to the metal.

12. A cartridge as claimed in claim 11 wherein the protein substrate comprises biotin.

13. A cartridge as claimed in claim 11 wherein the ligand comprises a protein selected from the group comprising avidin, strepavidin and neutravidin.

14. A Surface Plasmon Resonance sensor comprising a light source for generating a beam of light, a cartridge as claimed in claim 1, and a light beam detection means wherein the employment of the cartridge allows for the miniaturisation of the sensor.

15. A Surface Plasmon Resonance sensor as claimed in claim 14 wherein the light source comprises a diode laser.

16. A Surface Plasmon Resonance sensor as claimed in claim 14 wherein the light beam detection means comprises a detector and a data processing means.

17. A method of field detection of one or more pathogens that comprising the steps of:
1) Selecting an appropriate cartridge for the detection of one or more pathogens for use in a Surface Plasmon Resonance sensor;
2) Calibrating the Surface Plasmon Resonance sensor; and
3) Testing a fluid sample for the presence of one or more of the pathogens;

18. A method of field detection of one or more pathogens as claimed in claim 17 wherein the selection of the appropriate cartridge comprises locating the cartridge with one or more appropriate antibodies for binding with the one or more pathogens.

19. A method of field detection of one or more pathogens as claimed in claim 17 wherein calibration of the Surface Plasmon Resonance sensor comprises:
1) Irradiating a mounting member with a beam of light in the absence of the fluid sample; and
2) Detecting a component of the beam of light reflected from the mounting member and storing the data as a reference signal;

20. A method of field detection of one or more pathogens as claimed in claim 17 wherein the testing of a fluid sample for the presence of one or more pathogens comprises:
1) Locating the fluid sample with respect to a channel;
2) Connecting the channel to the cartridge;
3) Irradiating the fluid sample with the beam of light;
4) Detecting the beam of light reflected from the mounting member and storing the data as a sample signal; and
5) Comparing the sample signal with the reference signal.
